(19) United States
(12) Patent Application Publication
(10) Pub. No.: US 2011/0011999 A1
(43) Pub. Date: Jan. 20, 2011

(54) HANGING HOOK

(76) Inventor: Rafael Wischkin, Weston, CT (US)

Correspondence Address: ZIEGLER IP LAW GROUP, LLC., 518 RIVERSIDE AVENUE, BUILDING B (Synergy), WESTPORT, CT, 06880, US

(21) Appl. No.: 12/836,198

(22) Filed: Jul. 14, 2010

Related U.S. Application Data
(60) Provisional application No. 61/225,394, filed on Jul. 14, 2009.

(51) Int. Cl. F16M 13/02; F16B 45/00; F16B 2/06

(52) U.S. Cl. 248/225.21

(57) ABSTRACT

A hanging hook includes an attachment member configured to engage a support arm, the support arm being angled relative to a horizontal plane, an elongated shaft portion having a first and second ends, the elongated shaft portion being pivotally coupled to the attachment member at the first end, and a lower hook portion disposed at the second end of the elongated shaft portion, wherein the elongated shaft portion is configured to hang in a substantially vertical orientation when the attachment member is engaged on the support arm.

### CROSS-REFERENCE TO RELATED APPLICATIONS

This application claims priority to and the benefit of U.S. Provisional Application No. 61/225,394, which was filed on 14 Jul. 2009, the disclosure of which is incorporated herein by reference in its entirety.

### BACKGROUND

1. Field

The exemplary embodiments generally relate to devices for hanging objects, and more particularly, to devices for hanging objects from a support arm or strut of an umbrella or canopy type structure.

2. Brief Description of Related Developments

Umbrellas and canopy type structures come in a variety of different configurations. One configuration of an umbrella used for the beach, market or with a table generally includes a center pole that has a slidable collar. The collar is attached to a set of supporting arms or struts underneath the canopy of the umbrella. These supporting arms are connected on the other end to the outer edge of the umbrella. As the collar slides up, the supporting arms are pushed upward and out and the umbrella expands. Typically, when the umbrella is fully opened, the supporting arms are oriented at an angle relative to the center pole or other attachment point. They are not fully horizontal with respect to the center pole. As the collar is lowered, the supporting arms return towards a vertical position and the umbrella closes.

Expandable or portable canopies, such as awnings and tradeshow displays, are other examples of umbrella-type structures that include support arms or struts that extend underneath the canopy fabric at an angle relative to an attachment point.

It can be desirable to hang objects from these support arms. Examples of such objects can include, but are not limited to, lights, planters, clothing, accessories, or decorations.

Generally, the typical hooks that are used to hang objects underneath an umbrella are attached to or supported by the central pole of the umbrella. A clamp or similar device is secured to the central support pole in a semi-permanent fashion. Typically, the hooks are attached to the clamp, which is secured to the collar or center support. Once the clamp and hooks are secured, the hooks are not readily or easily movable. In some cases, it may also be desirable to hang an object higher up and away from the support pole, such as from the supporting arms. Due to the angled nature of such support arms, a simple hook or hanger will have a tendency to slide or move on the support arm. Whether attached to the central pole or a support arm, the hooking devices used in conjunction with umbrellas generally require tools or two-handed manipulation for proper installation. Additionally, due to the height of an outdoor umbrella, awning, marketing display, or other similar structure, it may be difficult to reach the support arm in order to hang an object from it, unless one stands on a stool or ladder.

It would be advantageous to be able to hang objects underneath an umbrella type structure in a secure manner, away from the central support pole, using a support or hanger that is easily installed and removed without the use of tools.

Accordingly, it would be desirable to provide an umbrella hook device that addresses at least some of the problems identified above.

### SUMMARY

As described herein, the exemplary embodiments overcome one or more of the above advantages or other disadvantages known in the art.

One aspect of the disclosed embodiments relates to a hanging hook. In one embodiment, the hanging hook includes an attachment member configured to engage a support arm, the support arm being angled relative to a horizontal plane, an elongated shaft portion having a first and second ends, the elongated shaft portion being pivotally coupled to the attachment member at the first end, and a lower hook portion disposed at the second end of the elongated shaft portion, wherein the elongated shaft portion is configured to hang in a substantially vertical orientation when the attachment member is engaged on the support arm.

In another aspect, the disclosed embodiments are directed to a hanging hook for a canopy. In one embodiment, the hanging hook includes an elongated shaft portion; an attachment member pivotally coupled to a first end of the shaft portion; a lower hook member coupled to a second end of the shaft portion; and wherein the attachment member comprises a releasable clamping member configured to securely engage a support arm of the canopy.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

The foregoing aspects and other features of the disclosed embodiments are explained in the following description, taken in connection with the accompanying drawings, wherein:

FIGS. 1A through 1C illustrate a hanging hook and an application thereof in accordance with an exemplary embodiment.

FIGS. 2A through 2C illustrate different embodiments of a hanging hook incorporating aspects of the present disclosure.

FIGS. 3A and 3B illustrate one embodiment of a clamping or securing member for a hanging hook incorporating aspects of the present disclosure.

FIGS. 4A and 4B illustrate one embodiment of a clamping or securing member for a hanging hook incorporating aspects of the present disclosure.

FIGS. 5A through 5D illustrate different embodiments of a clamping or securing member for a hanging hook incorporating aspects of the present disclosure.

FIGS. 6A and 6B are schematic illustrations of another embodiment of a hanging hook incorporating aspects of the present disclosure.

FIGS. 7A and 7B illustrate exemplary applications of a hanging hook incorporating aspects of the present disclosure.

FIGS. 8A through 8D illustrate alternate views of the clamping or securing member of FIGS. 4A-B incorporating aspects of the present disclosure.

FIGS. 9A through 9E illustrate further views of the clamping or securing member of FIGS. 4A-B incorporating aspects of the present disclosure.

### DETAILED DESCRIPTION OF THE EXEMPLARY EMBODIMENTS

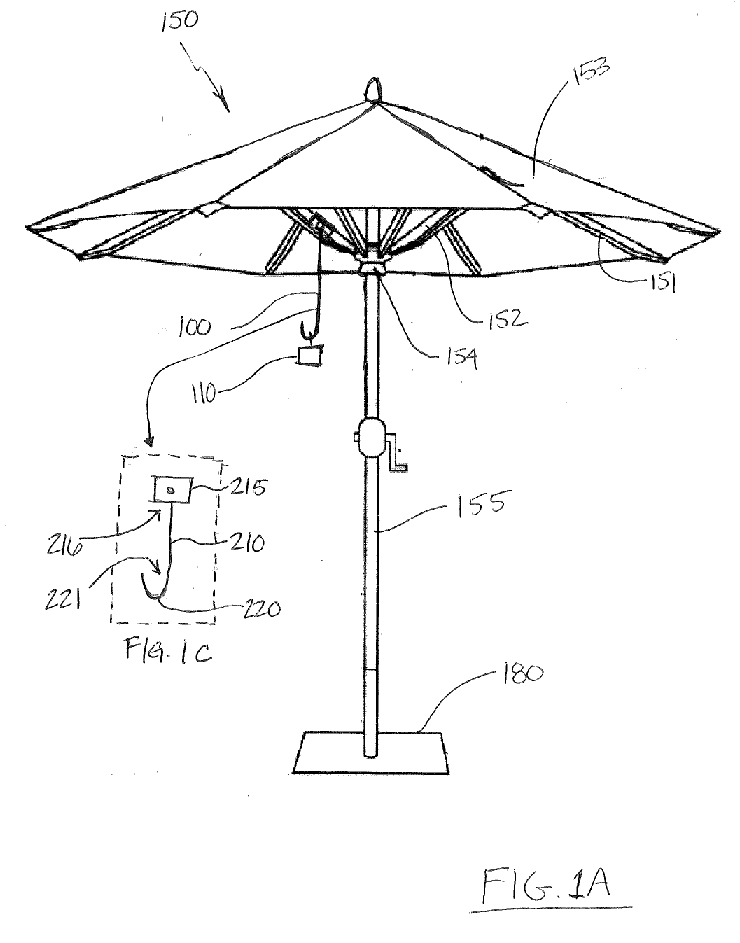

Referring to FIG. 1A, an exemplary hanging hook, herein also referred to as an umbrella hook or hanger, incorporating aspects of the disclosed embodiments is generally designated by reference numeral 100. The aspects of the disclosed embodiments are generally directed to an elongated device for hanging objects from angled or non-horizontal surfaces, otherwise referred to as arms or struts. These supports or arms can include for example, but are not limited to, umbrella, awning and canopy support arms, stair banisters, trellises, displays, crossbars, or beams, struts, etc. While the aspects of the disclosed embodiments will generally be described herein with respect to support arms for an umbrella, awning or canopy, the aspects of the disclosed embodiments are not so limited and encompass any similar style structure that is non-horizontal and from which it is desired to hang an object, such as a light or plant, for example.

The hanging hook device 100 of the disclosed embodiments is configured to be easily and securely attached to an angled support pole or member of a structure such as an outdoor umbrella. FIGS. 1A-1C illustrate one embodiment of an umbrella structure 150 and an umbrella hook 100 incorporating aspects of the present disclosure. Although the embodiments disclosed will be described with reference to the drawings, it should be understood that the embodiments disclosed herein can be embodied in many alternate forms. In addition, any suitable size, shape or type of elements or materials could be used.

As can be seen in FIG. 1A, a hanging hook 100 is shown suspended from umbrella 150. The umbrella 150 includes a central support pole 155, upper support arms 151, lower support arms 152, a movable collar or hub 154 and a canopy 153. The upper arms 151 are coupled at one end to the central support pole 155 at an upper hub (not shown). The lower arms 152 may be pivotally attached to the upper arms 151 and the lower hub 154 so that when the lower hub 154 is moved upwards along the central support pole 155 the lower arms 152 cause the upper arms 151 to spread and the umbrella 150 is opened. The central support pole 155 may be supported in a substantially vertical orientation in any suitable manner such as by, for example, inserting the central support pole 155 into a base 180.

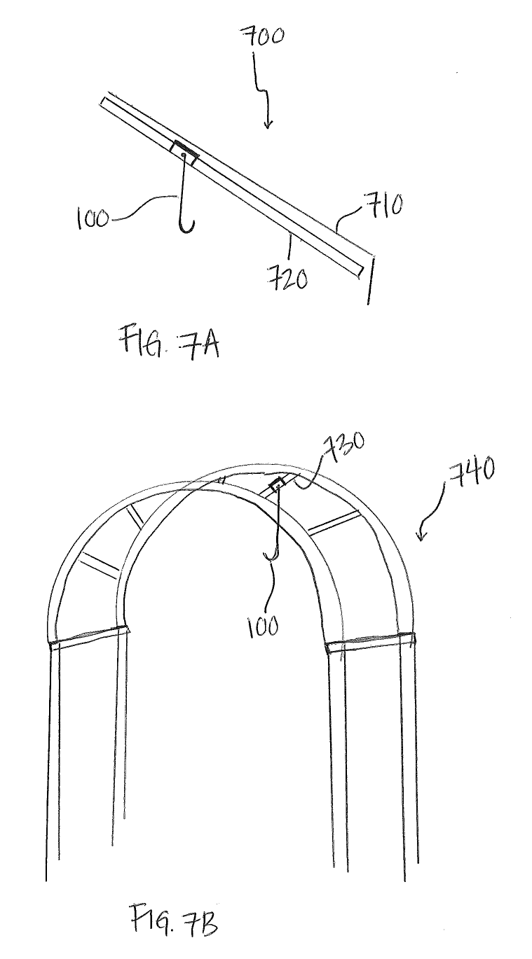

Referring to FIG. 1B, it is noted that the umbrella 150 may be inserted through an opening 156 in a table 120 either in conjunction with or instead of using a base for support. Alternately, the center support pole 155 may be inserted into the ground. It should also be understood that while the exemplary embodiments are described with respect to an umbrella having a central support pole that is generally supported on the ground, the exemplary embodiments apply equally to umbrellas that are supported (e.g. cantilevered) from a wall or any other suitable umbrella having upper and lower arms (or other suitable framework) to which the umbrella hooks described herein can be attached. FIG. 7A illustrates an exemplary awning 700 with cloth canopy 710 and one embodiment of a hanging hook 100 engaged on or with supporting arm 720. FIG. 7B illustrates an exemplary trellis 740 with one embodiment of a hanging hook 100 engaged on or with supporting arm or beam 730.

As can be seen in FIG. 1A, the umbrella hook 100 is configured to hang on or from one of the lower supporting arms 152. It is noted that while only one hanging hook 100 is shown hanging from the lower arm 152, in other examples, any suitable number of hooks 100 may hang from one or more lower arms 152 of the umbrella 150. As will be described in greater detail below the hanging hook 100 is configured so an object 110 may be hung therefrom underneath the umbrella 150. Examples of suitable objects include, but are not limited to, lanterns (or other lights), flower pots, insect repellants and decorations. The hanging hook 100 of the disclosed embodiments allows objects to be hung from the arms 152 of umbrella 150 in an aesthetically pleasing arrangement. Although the aspects of the disclosed embodiments will be described herein with respect to arm 152 of umbrella 150, the arm 152 is generally intended to encompass any suitable strut or similar structure from which the hanging hook of the embodiments disclosed herein will be hung, other than including a lower support arm of an umbrella.

As illustrated in FIG. 1B, hanging hook 100 is positioned substantially in the middle of the arm 152. It should be understood, however, that the hanging hook 100 may also be positioned at any suitable position or distance D away from the central support pole 155.

Referring now to FIG. 1C, in one exemplary embodiment the hanging hook 100 includes an elongated shaft portion 210, an attachment member 215, and a lower hook member 220. The attachment member 215 will generally be configured to be securely attached to the lower supporting arm 152 as is described herein. The lower hook member 220 will be configured to allow an object to be hung there from. It is noted that the shaft portion 210, attachment member 215 and lower hook member 220 may be constructed of any suitable material such as metal, plastics, composites or any combination thereof. In one embodiment, the shaft portion 210 and lower hook member 220 may be integrally formed with each other in a unitary one-piece construction or be joined to each other in any suitable manner (e.g. welding, gluing, etc.). Alternatively, the lower hook member 220 can be separately attached to the shaft portion 210. For example, in one embodiment, the lower hook member 220 and shaft 210 can include a suitable attachment mechanism that allows the lower hook member 220 to be releasably attached to the shaft 210, such as a screw. In this example, one end of the hook member 220 could be threaded and received in a corresponding threaded opening or receiver in that end 221 of the shaft 210. In one embodiment, the lower hook member 220 can be rotatably attached to the shaft 210, so that the lower hook member 220 rotates or swivels when attached to the shaft 210. This can provide the advantage of allowing the object 110 that is hung from the hook 220 to be rotated to an optimum or desired position. It is understood that, although hook member 220 is herein illustrated and described as a J-hook type member, the hook member 220 can comprise any suitable attachment mechanism for securing an object 110 to the hanging hook device 100. These can include for example, but are not limited to, clips, clamps, D-ring devices or other such devices that can grasp or secure an object 110 to the lower end 221 of the shaft 210.

In the example shown in FIG. 1C, the shaft portion 210 is pivotally attached to the attachment member 215. In one embodiment, the attachment member 215 is a clamp or bracket type member configured to engage with arm 152. The configuration of the umbrella hook 100 as described herein allows a user to easily attach and remove the umbrella hook 100, as well as any objects 110 hanging from the umbrella hook 100. In this example, the attachment member 215 is located at a first end 216 of the shaft portion 210 and the second or lower hook member 220 is located at a second end 221 of the shaft portion 210.

The shaft portion 210 may have any suitable length configured to allow a user to easily reach and attach/remove the attachment member 215 to the arm 152, as well as easily access an object 110 hung from the umbrella hook 100. In this example, the attachment member 215 and lower hook member 220 are shown extending from the shaft portion 210 along substantially the same plane with one another, meaning they are substantially in-line. In alternate embodiments, the lower hook member 220 may have any suitable angular relationship with respect to attachment member 215 such as, for example, where each extends from the shaft portion 210 in a substantially perpendicular relationship to one another.

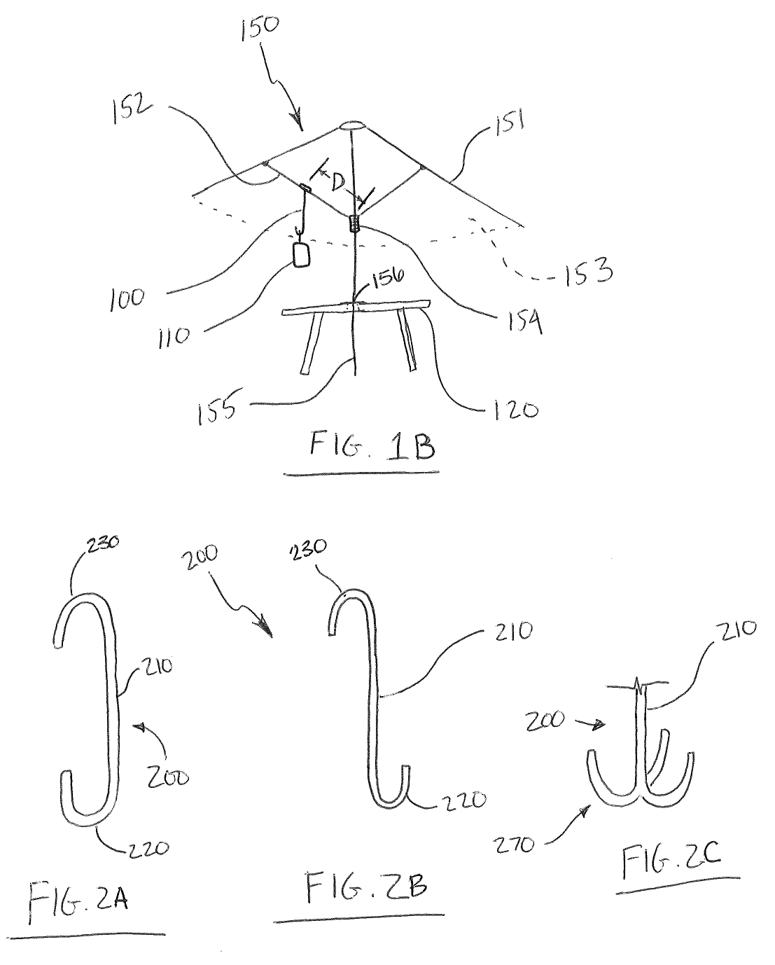

FIGS. 2A-2C illustrate alternative embodiments of the hanging hook 100 illustrated in FIG. 1. In the example of FIGS. 2A and 2B, the hanging hook, shown as hanging hook 200, has two hook portions 220, 230, located on opposing ends of the shaft portion 210. The two hook portions 220, 230 may be suitably sized and shaped so that a respective hook, such as hook 230, is configured to at last partially surround and be secured to the arm 152. While the hook portions 220, 230 are generally shown and described having a cylindrical structure, in alternate embodiments, the hook portions 220, 230, as well as the shaft 210, can comprise any suitable geometric shape, such as square, rectangular or flattened. When hook portion 230 is engaged with the arm 152, or other similar structure, the shaft portion 210 is configured to hang in a substantially vertical orientation.

In one embodiment, the arm 152 can be configured with a stop member positioned along the arm 152 to prevent the hanging hook 200 from sliding along the arm 152 when an object 110 is hung from the hook 200. In one example, a clamp, adhesive or other suitable stop member may be placed on the arm 152 adjacent to the hook 200 to substantially prevent sliding movement of the hook 200 on the arm 152. In another example, an attachment device may be mechanically, chemically or otherwise bonded to the arm 152 so that the hanging hook 200 may hang from the attachment device attached to the arm 152. For exemplary purposes only, the attachment device may include an eye-screw, a hook or other protrusion that that is configured to hold a hook portion 220, 230 of the hanging hook 200 on the arm 152 without substantial sliding movement of the hanging hook 200 along the arm 152.

In another embodiment, the hook portions 220, 230 of the umbrella hook 200 may include or be coated with any suitable anti-skid material (e.g. rubber, foam, abrasives, adhesives, etc.) to substantially prevent sliding movement of the hook 200 on the arm 152. In alternate embodiments the hook portions 220, 230 may be adjustable in size so as to actively grip the lower arm for substantially preventing sliding movement of the umbrella hook 200 on the arm 152.

As shown in FIG. 2A, the hook portions 220 and 230 may extend from the shaft portion 210 in substantially the same direction. Alternatively, the hook portions 220, 230 may extend in opposite directions from one another (or at a 180 degree orientation), as shown in FIG. 2B. While the umbrella hook 200 illustrated in FIG. 2A is shown with a single hook 220 for supporting an object 110, in alternate embodiments, such as that illustrated in FIG. 2C, the hook portion 270 can include multiple hooks or attachment devices.

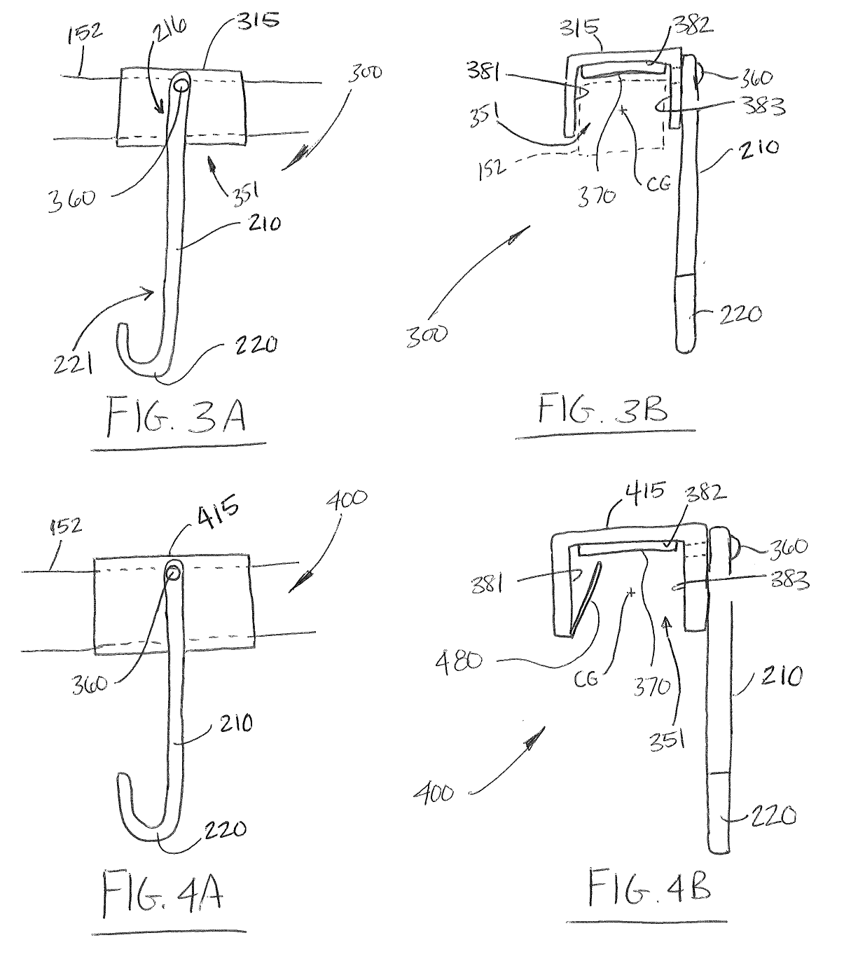

Referring now to FIGS. 3A and 3B, one embodiment of an umbrella hook 300 incorporating aspects of the disclosed embodiments includes an attachment member 315, an elongated shaft portion 210 and a lower hook portion 220. In this embodiment, the attachment member 315 may have any suitable shape and size for at least partially surrounding and engaging one or more sides of the arm 152 (represented by dashed lines) of umbrella 150. For example, the attachment member 315 may include a U-shaped channel having an open side 351 configured to substantially engage, for example, three sides of arm 152, where the arm 152 has a square cross section. Although a substantially square cross section is referred to herein, in alternate embodiments the cross-section can be any suitable geometric configuration, such as for example, circular, rectangular or triangular. The attachment member 315 of the disclosed embodiments is generally configured to conform to any suitable shape of the arm 152.

As illustrated in FIGS. 3A and 3B, in one embodiment, a first end 216 of the shaft portion 210 may be pivotally connected to the attachment member 315 by a pivotal attachment member 360. For exemplary purposes only, the pivotal attachment member 360 may be any suitable fastener, clip, hook or screw, or threaded stud that joins the attachment member 315 to the first end 216 of the shaft portion 210 in such a way that the shaft portion 210 may rotate freely about the pivot point 360. The pivotal attachment member 360 coupling the shaft portion 210 and the attachment member 315 allows the shaft portion 210 to hang (via gravity) or otherwise be suspended from the attachment member 315 in a substantially vertical orientation (e.g. substantially parallel to the central support pole 155) regardless of the angle of the arm 152 to which the attachment member 315 is affixed. The lower hook portion 220 is located at the second end 221 of the shaft portion and can be substantially similar to the hook portions described above with respect to FIGS. 1 and 2.

It is noted that the center of gravity CG of the attachment member 315 is generally located relative to the pivot point 360 such that as the hook 300 is held by a user along the shaft portion 210 (or hook portion 220) the open side 351 of the attachment member 315 is facing down (e.g. towards the ground). Because the open side 351 of the attachment member 315 is always facing down when the hook 300 is held by the shaft portion 210 (or hook portion 220), the hook 300 can be easily attached to a support such as arm 152 without having to manually manipulate the attachment member 315 for engagement with the arm 152. As such, a user wishing to install the attachment member 315 on the arm 152 of the umbrella 150 may do so one-handedly, even if the umbrella is completely opened. For example, in the case of a table umbrella 150 as shown in FIG. 1A, the user can hold the shaft 210 of the hanging hook 100 and reach up to place the attachment member 215 of the hanging hook 100 over the arm 152. The length of the shaft portion 210 will generally be of a length that allows the attachment member 215 to be placed over and on the arm 152 without the need to utilize a stool or other similar height adjustment tool. In one embodiment, the hook portion 220 can be configured to be adjustable or extendable, such as by using a screw type mechanism, to increase or decrease the overall length of the hanging hook 100. If more length is desired or needed, the hook portion 220 could be turned in a suitable direction to increase the overall length.

In one embodiment, referring to FIG. 3B, the attachment member 315 may include an anti-skid member 370 that is configured to prevent the attachment member 315 from moving on the arm 152. The anti-skid member 370 can be placed or formed on any one or more of the inner surfaces 381, 382 and 383 of the attachment member 315, and is configured to engage with at least one surface of the arm 152. Examples of anti-skid devices or members can include, but are not limited to, a gripping or anti-skid pad or teeth or other protrusions on one or more of the inner surfaces 381, 382 and 383 of the attachment member 315. The anti-skid member 370 may be constructed of any suitable anti-skid material including, but not limited to, rubber, foam, metal, composites and abrasive materials. The anti-skid member 370 may be a separate component which is affixed to an inner surface 381-383 of the attachment member 315 or, alternately, the anti-skid member 370 may be constructed from and integrated into the attachment member 315. For instance, metal gripping teeth may be formed on an inner surface 381-383 of the attachment member 315 by puncturing or perforating the material of the attachment member 315. The gripping teeth will protrude from one or more of the inner surfaces 381-383 of the attachment member 315 and engage the corresponding surface(s) of the arm 152.

Referring now to FIGS. 4A and 4B, another exemplary hanging hook 400 incorporating aspects of the disclosed embodiments is shown. In this and the other examples, certain aspects of the hanging hook 400 can be substantially similar to the hanging hooks 100, 200 and 300 so that like features (e.g. pivot point 360, shaft portion 210, lower hook portion 220 and anti-skid portion 370) are similarly numbered. In this example, the attachment member 415 of hanging hook 400 is substantially the same as the attachment member 315 described above. However, in this example, the attachment member 415 also includes at least one clamping member 480 located on an inner surface 381 thereof. The clamping member 480 is shown in this example as a leaf spring which is formed of one piece with and made of the same material as attachment member 415. In alternate embodiments, the clamping member 480 may be a separate piece attached to attachment member 415 by any suitable method such as, for example, welding, gluing, etc. In further embodiments, the clamping member may include one or more of a thumb screw, set screw, a lever actuated clamping device or any other spring activated clamping device. The clamping member 480 may be any suitable clamping member made of any suitable material such as spring steel, plastics, or other metals. The clamping member 480 is configured to removably grip the arm 152 of the umbrella for substantially preventing the sliding movement of the attachment member 415 (and the hook 400) along the lower arm 152. In one embodiment, the attachment member 415 may further include an anti-skid member 370, similar to that described with reference to FIG. 3B, for providing further anti-skid properties, however, this combination is not essential.

The leaf spring clamping member 480 as depicted in FIGS. 4A, 4B provides the advantage and allows the attachment member 415 to be “self-fitting” or securable, while at the same time easily releasable. Clamping member 480 is configured to self-compress when brought into contact with arm 152 and continues to exert inward pressure on the arm 152 for as long as the attachment member 415 is engaged therewith. For example, a user wishing to install the hanging hook 400 onto the arm 152 of an umbrella 150 may do so without the use of tools or other manual manipulation of the attachment member 415. In fact, installation of the hanging hook 400 (100-300 included as well) may be done with one hand, by holding onto solely shaft portion 210 or hook portion 220. In addition, the “self-fitting” properties of leaf spring-type clamping member 480 allow the attachment member 415 to securely grip the arm 152, even when the arm 152 may be configured in different sizes and shapes. The gripping properties of the leaf spring configuration also allow the clamp 480 to be positioned on the arm 152 both from the top or from the bottom. The simple construction of the clamp member 480 increases ease of use and reduces the likelihood of lost components such as screws, bolts, etc. in transportation of the hanging hook 400.

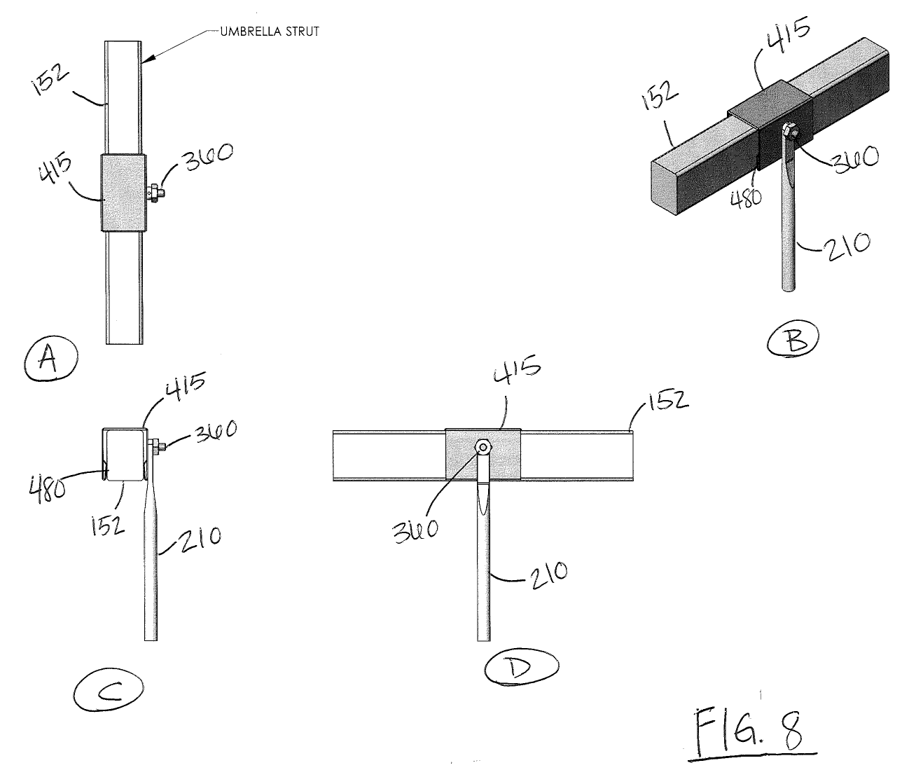

FIGS. 8A through 8D illustrate additional views of the attachment member 415 portion of the hook 400 of FIGS. 4A-B. FIGS. 8A and 8D illustrate top and side views, respectively, of attachment member 415 being engaged on arm 152. FIG. 8C illustrates a view along support arm 152 showing the attachment member 415 engaged with the arm 152. As is shown in FIG. 8C, the clamping member(s) 480 is engaged or compressed, which causes it to exert pressure on, support arm 152, thus allowing the attachment member 415 to be securely engaged without sliding. FIG. 8B illustrates yet a further view of the attachment member 415 engaged on support arm 152. In this embodiment, the pivot attachment 360 comprises a screw mechanism that couples the attachment member 415 to elongate shaft portion 210. It is noted again that the function of pivot attachment 360 allows shaft portion 210 to hang in a substantially vertical orientation when attachment member 415 is engaged on the support arm 152, regardless of the angle of arm 152.

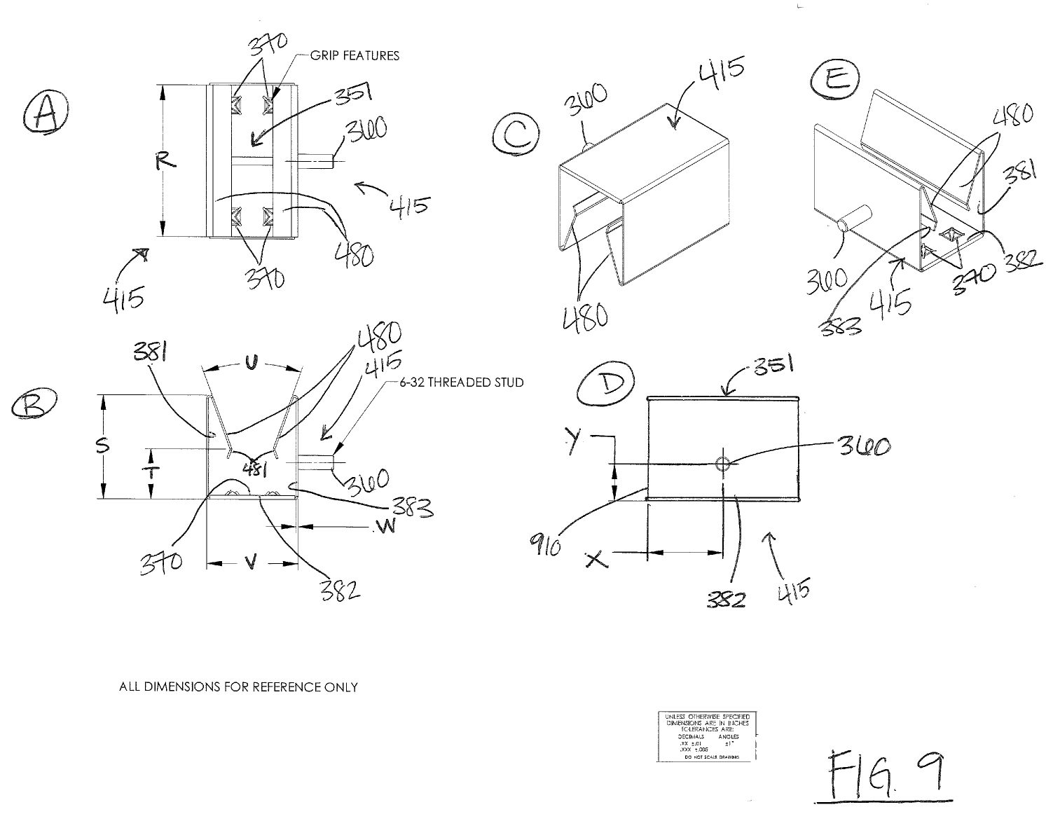

Further embodiments and views of the attachment member 415 of FIGS. 4A-B are illustrated in FIGS. 9A through 9E. FIG. 9A illustrates a view of the open side 351 of attachment member 415. FIGS. 9B through 9E present additional views of attachment member 415 showing the anti-skid members 370, pivot attachment member 360, clamping members 480. In this embodiment, the attachment member 415 includes two clamping members 480.

Generally, the attachment member 415 is of a substantially rectangular shape with Length R, width V and height S. In one embodiment, the clamping members 480 are angled out from sides 381, 383 at an angle U and the ends 481 of clamping members 480 are located a distance T from side 382 of attachment member 415. As illustrated in FIG. 9D, pivot attachment member 360 is located horizontal distance X from an end 910 and vertical distance Y from side 382 of attachment member 415.

In one embodiment, the length R is in the range of approximately 0.5 to 2.5 inches, and preferably approximately 1.5 inches. The width V can be in the range of approximately 0.5 to 1.5 inches, and preferably approximately 0.9 inches. The height S can be in the range of approximately 0.5 to 2 inches, and preferably approximately 1.0 inches. In alternate embodiments, the dimensions R, V and S can be any suitable combination of dimensions that allow the attachment member 415 to securely engage with a support arm 152 of any suitable shape or size. In one embodiment, the two clamping members 480 may be situated at an angle U in the range of approximately 20-60 degrees, and preferably approximately 40 degrees from the inner sides 381, 383 of attachment member 415 in order to allow secure engagement with, and gripping of the sides of support arm 152. The ends 481 of clamping members 480 may be located at a suitable distance T inches from side 382 of attachment member 415, which in this example is approximately 0.5 inches. As illustrated in FIG. 9D, in one embodiment, the pivot member 360 may be located substantially in the approximate center lengthwise, or as shown in this example, approximately 0.75 inches from an end 910 of attachment member 415, and vertically Y approximately 0.40 inches. It is understood that the above described dimensions are for exemplary purposes only, and are not meant to be limited. Any suitable dimensions, so as to enable attachment member 415 to engage on support arms 152 of a variety of sizes and shapes, are also within the intended scope of the disclosed embodiments. It is also understood that FIGS. 9A through 9E are not necessarily drawn to scale.

As illustrated in FIGS. 9A through 9E, anti-skid member(s) is comprised of a number of protrusions or teeth which have been created in side 382 of attachment member 415. These teeth or protrusions may be created, for example, by punching or puncturing the material of attachment member 415. Alternately, teeth or other anti-skid members may be created by roughening the surface 382 of attachment member 415 by grinding, etching, or other means. In alternate embodiments, anti-skid member may be any suitable anti-skid member as described with respect to FIGS. 4A-B. While anti-skid member(s) 370 is located on side 382 of attachment member 415 in these figures, it is understood that anti-skid member may additionally be included on any other one side, 382, 383, or on any combination of sides 381-383.

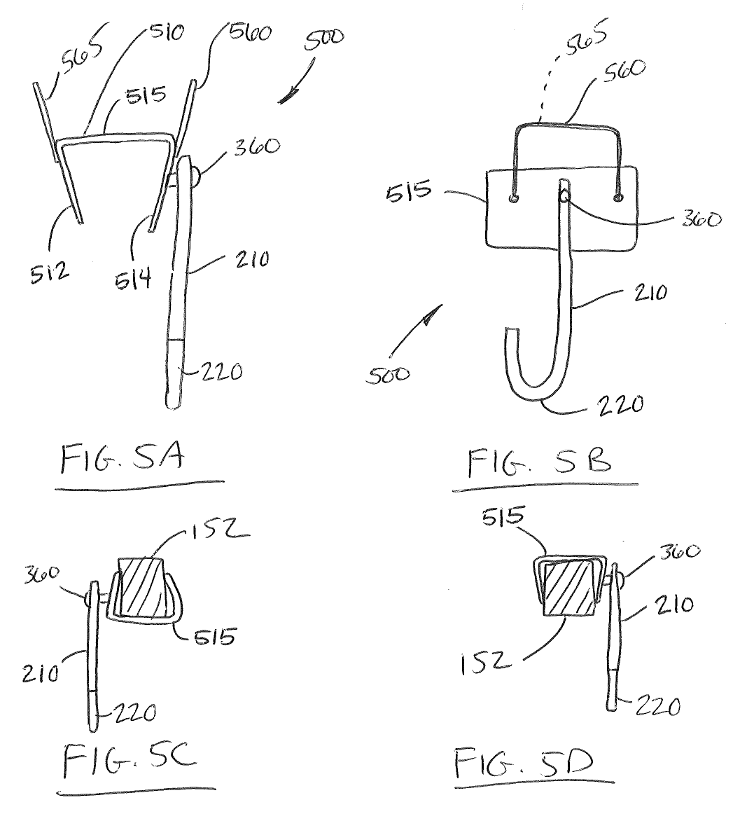

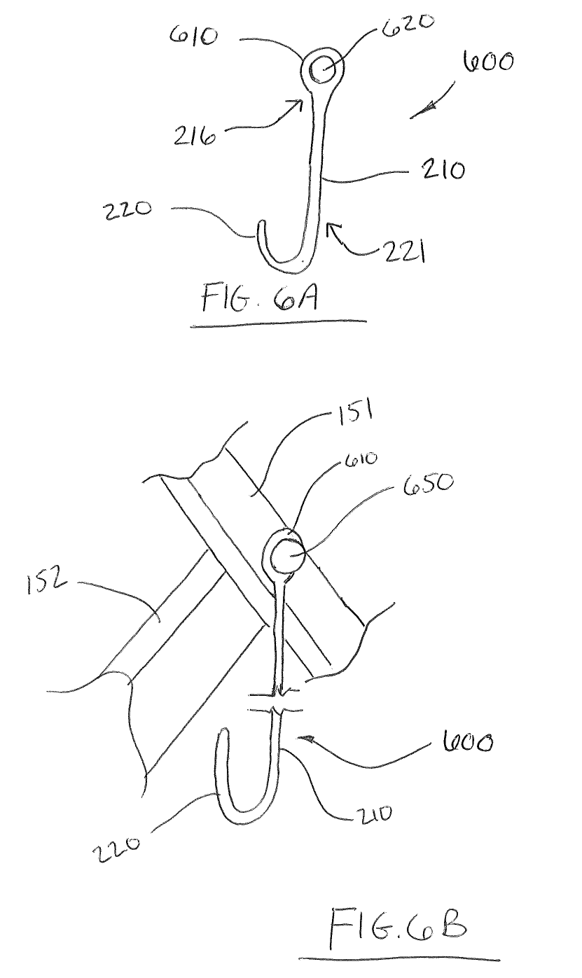

Referring to FIGS. 5A and 5B another exemplary embodiment of a hanging hook 500 is shown. In this example, the hanging hook 500 can include aspects that are substantially similar to those described with respect to the other embodiments, unless otherwise noted, such that like features have like reference numerals (pivot point 360, shaft portion 210 and hook portion 220). In one embodiment the attachment member 515 comprises a clamping structure formed of, for example, a resiliently flexible material. The resiliently flexible material may be any suitable resilient material such as, for example, spring steel or plastics. Two sides of the flexible attachment member 550 form legs 514, 512. Suitable tabs 560, 565 or other extension members may extend from legs 514, 512 on an opposite side of attachment member 515 so that the tabs 560, 565 and legs 514, 512 extend in substantially opposite directions, or at a 180 degree orientation to one another. The tabs 560, 565 may be rigidly attached to the legs 514, 512 or they may be foldable with respect to legs 514, 512. In alternate embodiments, the tabs 560, 565 may be attached to the legs 514, 512 or to attachment member 515 in any suitable manner to perform the spreading of the legs 514, 512 described below.

In this embodiment, tabs 560, 565 are configured to allow the legs 514, 512 to be spread apart far enough to allow attachment member 515 to receive and engage arm 152. As the tabs 560, 565 are released, the resiliently flexible legs 514, 512 move back together, thus gripping arm 152 to substantially prevent sliding movement of the hanging hook 500 along the arm 152. In a further embodiment, one or more of legs 514, 512 or surfaces of the open side of attachment member 550 may comprise an anti-skid member 370, as described with respect to FIGS. 3A, 3B.

It is noted that the pivotal attachment member 360 allows the shaft portion 210 to hang in a substantially vertical orientation when the attachment member 515 is engaged with arm 152. Additionally, since in one embodiment, the pivot point 360 can be configured to allow shaft portion 210 to rotate approximately 180 to 360 degrees relative to the attachment member 515, the hanging hook 500 can be installed both from the top or the bottom of the lower arm 152 as illustrated in FIGS. 5C and 5D.

FIGS. 6A and 6B illustrate another alternate embodiment of a hanging hook 600. In this example, aspects of the hanging hook 600 are substantially similar to aspects of the hanging hook 200 described above with respect to FIGS. 2A-C, unless otherwise noted, such that like features have like reference numerals. As can be seen in FIG. 6A hanging hook 600 includes shaft portion 210, a lower hook portion 220 and a ring or eye portion 610 as the attachment member. In one embodiment, the ring portion 610 is integrally formed on the first end 216 of the shaft portion 210 in for example, a unitary one-piece construction. In alternate embodiments, the ring portion 610 may be formed separately and affixed to the shaft portion 210 in any suitable manner, such as by mechanical fasteners, chemical fasteners or welding. The ring portion 610 is shaped to form an aperture 620. The aperture 620 is sized so that a fastener can pass through the ring 610 for securing the hanging hook 600 to an arm 152.

In this example, as illustrated in FIG. 6B, the ring portion 610 may be secured to a fastener 650 that hingably joins the arm 151 to a respective one of the arms 152, thus securing the hanging hook 600 at a joint between the arms 151, 152 of the umbrella 150. In this example, ring portion 610 may be used to secure hanging hook 600 to any existing protrusion or fastener on the structural elements of umbrella 150. In an alternate embodiment, a suitable fastener, hook, or protrusion may be coupled to a structural element of umbrella 150, such as the arms 151, 152, in order to thus secure umbrella hook 600 using ring portion 610. In this example, hanging hook 600 may be either removably or more permanently fixed to the structure of umbrella 150, depending on the nature of the fastener, hook or protrusion 650 that is used. If fastener 650 secures the hanging hook 600 in a substantially permanent manner, hanging hook 600 is not intended to be removed or will not fall off of the umbrella 150 when the umbrella 150 is closed and opened. In further embodiments, the hanging hook 600 may be affixed to umbrella 150 during manufacture.

The aspects of the disclosed embodiments relate to an elongated hook comprising a shaft portion, an attachment portion configured to engage an arm of an umbrella or awning, and a second hook portion configured to receive an object for hanging. These embodiments, as disclosed in detail herein, allow a user to easily, and without the use of tools, install and remove the hanging hook of the disclosed embodiments from the supporting arms of an umbrella or other canopy-type structure for hanging various objects underneath. The “self fitting” properties of the umbrella hook allow it to fit varying sizes and shapes of support arms.

It should be understood that the foregoing description is only illustrative of the embodiments. While there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hanging hook comprising:
an attachment member configured to engage a support arm, the support arm being angled relative to a horizontal plane;
an elongated shaft portion having first and second ends, the elongated shaft portion being pivotally coupled to the attachment member at the first end; and
a lower hook portion disposed at the second end of the elongated shaft portion,
wherein the elongated shaft portion is configured to hang in a substantially vertical orientation when the attachment member is engaged on the support arm.

2. The hanging hook according to claim 1 further comprising at least one clamping member disposed on an inner wall of the attachment member, the clamping member being configured to removably engage the angled arm.

3. The hanging hook according to claim 2 wherein the clamping member is a leaf spring.

4. The hanging hook according to claim 2 wherein the clamping member is spring steel or plastic.

5. The hanging hook according to claim 1 further comprising at least one anti-skid member disposed on an inner wall of the attachment member, the anti-skid member being configured to substantially prevent sliding movement of the attachment member when engaged on the supporting lower arm.

6. The hanging hook according to claim 5 wherein the anti-skid member is rubber, foam, abrasive material, or adhesive material.

7. The hanging hook according to claim 5 wherein the gripping member is comprised of a plurality of perforated teeth.

8. The hanging hook according to claim 1 further comprising three or more hook portions disposed at the second end of the elongated shaft portion.

9. The hanging hook according to claim 1 wherein the support arm is a support arm for an umbrella, awning or canopy.

10. The hanging hook according to claim 1 wherein the lower hook portion is rotatably attached to the elongated shaft portion.

11. A hanging hook for a canopy comprising:
an elongated shaft portion;
an attachment member pivotally coupled to a first end of the shaft portion;
a lower hook member coupled to a second end of the shaft portion; and
wherein the attachment member comprises a releasable clamping member configured to securely engage a support arm of the canopy.

12. The hanging hook of claim 11 wherein the attachment member is configured to secure the hanging hook to the support arm when the support arm is angled relative to a horizontal plane.

13. The hanging hook of claim 11 wherein the attachment member comprises a first side, a second side and a third side coupling the first and second sides and an opening between the first side and second side that is configured to be placed over the support arm.

14. The hanging hook of claim 13 wherein the clamping member is coupled to an inner surface of the attachment member that engages a side of the support arm when the attachment member is placed over the support arm.

15. The hanging hook of claim 14 wherein the clamping member comprises a leaf spring.

16. The hanging hook of claim 13 further comprising an anti-skid member on the inner surface of the attachment member, the anti-skid member configured to engage at least one side of the support arm when the attachment member is placed over the support arm.

17. The hanging hook of claim 16 wherein the anti-skid member is on an inner surface of the attachment member that opposes the flexible clamping member.

18. The hanging hook of claim 12 wherein the elongated shaft is configured to be oriented in a substantially vertical orientation when an object is hung from the lower hook member.

19. The hanging hook of claim 11 wherein the attachment member comprises a substantially U-shaped member, wherein an open side of the U-shaped member is configured to engage over a top of the support arm, and wherein one inner surface of the U-shaped member includes the releasable clamping member and another inner surface of the inner portion includes an anti-skid member.

20. The hanging hook of claim 11 wherein the attachment member is configured to engage the support arm from underneath a bottom of the support arm.
